(19) United States
(12) Patent Application Publication
(10) Pub. No.: US 2026/0281326 A1
(43) Pub. Date: Sep. 17, 2026

(54) METHODS AND APPARATUS OF COMBINED PREDICTION MODE WITH MORE INTER MODES FOR VIDEO CODING

(71) Applicant: MEDIATEK INC., Hsinchu City (TW)

(72) Inventors: Man-Shu CHIANG, Hsinchu City (TW); Chih-Wei HSU, Hsinchu City (TW); Tzu-Der CHUANG, Hsinchu City (TW)

(21) Appl. No.: 19/473,100

(22) PCT Filed: Oct. 23, 2024
(86) PCT No.: PCT/CN2024/126633

§ 371 Date: Oct. 6, 2025

Related U.S. Application Data
(60) Provisional application No. 63/592,604, filed on Oct. 24, 2023.

(51) Int. Cl. H04N 19/107; H04N 19/105; H04N 19/12; H04N 19/132; H04N 19/159; H04N 19/172; H04N 19/176; H04N 19/182; H04N 19/186; H04N 19/61

(52) U.S. Cl. CPC H04N 19/107; H04N 19/105; H04N 19/12; H04N 19/132; H04N 19/159; H04N 19/172; H04N 19/176; H04N 19/182; H04N 19/186; H04N 19/61

(57) ABSTRACT

A method and apparatus for video coding are disclosed. According to the method, input data associated with a current block is received, wherein the input data comprise pixel data to be encoded at an encoder side or coded data associated with the current block to be decoded at a decoder side. Combined prediction comprising target inter prediction and at least one of target intra prediction and neighbouring reconstructed samples is determined, wherein the target inter prediction refers to subblock-based inter prediction or GPM (Geometric Partitioning Mode)-related prediction. The current block is encoded or decoded by using prediction data comprising the combined prediction.

### CROSS REFERENCE TO RELATED APPLICATIONS

The present invention is a non-Provisional Application of and claims priority to U.S. Provisional Patent Application No. 63/592,604, filed on Oct. 24, 2023. The U.S. Provisional Patent Application is hereby incorporated by reference in its entirety.

### FIELD OF THE INVENTION

The present invention relates to video coding methods. In particular, the present invention relates to deriving combined prediction, where the inter prediction can refer to subblock-based prediction or GPM-related prediction.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, is provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

Intra Mode Coding with 67 Intra Prediction Modes

To capture the arbitrary edge directions presented in natural video, the number of directional intra modes in VVC is extended from 33, as used in HEVC, to 65.

In VVC, several conventional angular intra prediction modes are adaptively replaced with wide-angle intra prediction modes for the non-square blocks.

### Intra Mode Coding

To keep the complexity of the Most Probable Mode (MPM) list generation low, an intra mode coding method with 6 MPMs (or called primary MPMs) is used by considering two available neighbouring intra modes. The following three aspects are considered to construct the MPM list:
Default intra modes
Neighbouring intra modes
Derived intra modes

### Wide-Angle Intra Prediction (WAIP) for Non-Square Blocks

Conventional angular intra prediction directions are defined from 45 degrees to −135 degrees in clockwise direction. In VVC, several conventional angular intra prediction modes are adaptively replaced with wide-angle intra prediction modes for non-square blocks.

To support these prediction directions, the top reference with length 2W+1, and the left reference with length 2H+1, are defined as shown in FIG. 2A and FIG. 2B.

### Decoder Side Intra Mode Derivation (DIMD)

When DIMD is applied, two intra modes are derived from the reconstructed neighbour samples (template), and those two predictors are combined with the planar mode predictor with the weights derived from the gradients. The DIMD mode is used as an alternative prediction mode and is always checked in the high-complexity RDO mode.

To implicitly derive the intra prediction modes of a block, a texture gradient analysis is performed at both encoder and decoder sides. This process starts with an empty Histogram of Gradient (HoG) with 65 entries, corresponding to the 65 angular modes. Amplitudes of these entries are determined during the texture gradient analysis.

In the first step, DIMD picks a template of T=3 columns and lines from respectively left and above current block. This area is used as the reference for the gradient based intra prediction modes derivation.

In the second step, the horizontal and vertical Sobel filters are applied on all 3×3 window positions, centred on the pixels of the middle line of the template. On each window position, Sobel filters calculate the intensity of pure horizontal and vertical directions as Gₓ and G_{y}, respectively. Then, the texture angle of the window is calculated as:

$$angle = arctan ( {G}_{x} / {G}_{y} ) , \qquad ( 1 )$$

which can be converted into one of 65 angular intra prediction modes. Once the intra prediction modes index of current window is derived as idx, the amplitude of its entry in the HoG[idx] is updated by addition of:

$$ampl = \vert {G}_{x} \vert + \vert {G}_{y} \vert \qquad ( 2 )$$

FIG. 3 shows an example of HoG, calculated after applying the above operations on all pixel positions in the template. FIG. 3A illustrates an example of selected template 320 for a current block 310. Template 320 comprises T lines above the current block and T columns to the left of the current block. For intra prediction of the current block, the area 330 at the above and left of the current block corresponds to a reconstructed area and the area 340 below and at the right of the block corresponds to an unavailable area. FIG. 3B illustrates an example for T=3 and the HoGs are calculated for pixels 360 in the middle line and pixels 362 in the middle column. For example, for pixel 352, a 3×3 window 350 is used. FIG. 3C illustrates an example of the amplitudes (ampl) calculated based on equation (2) for the angular intra prediction modes as determined from equation (1).

Once HoG is computed, the indices with two tallest histogram bars are selected as the two implicitly derived intra prediction modes (IPMs) for the block and are further combined with the Planar mode as the prediction of DIMD mode. The prediction fusion is applied as a weighted average of the above three predictors.

### Template-Based Intra Mode Derivation (TIMD)

Template-based intra mode derivation (TIMD) mode implicitly derives the intra prediction mode of a CU using a neighbouring template at both the encoder and decoder, instead of signalling the intra prediction mode to the decoder. As shown in FIG. 4, the prediction samples of the template (412 and 414) for the current block 410 are generated using the reference samples (420 and 422) of the template for each candidate mode. A cost is calculated as the SATD (Sum of Absolute Transformed Differences) between the prediction samples and the reconstruction samples of the template. The intra prediction mode with the minimum cost is selected as the TIMD mode (similar to the derivation for the DIMD mode) and used for intra prediction of the CU. The candidate modes may be 67 intra prediction modes as in VVC or extended to 131 intra prediction modes. In general, MPMs can provide a clue to indicate the directional information of a CU. Thus, to reduce the intra mode search space and utilize the characteristics of a CU, the intra prediction mode can be implicitly derived from the MPM list.

For each intra prediction mode in MPMs, the SATD between the prediction and reconstruction samples of the template is calculated. First two intra prediction modes with the minimum SATD are selected as the TIMD modes. These two TIMD modes are fused with weights after applying PDPC process, and such weighted intra prediction is used to code the current CU. Position dependent intra prediction combination (PDPC) is included in the derivation of the TIMD modes.

The costs of the two selected modes are compared with a threshold, in the test, the cost factor of 2 is applied as follows:

$$costMode 2 < 2 * costMode 1.$$

If this condition is true, the fusion is applied, otherwise only model is used. Weights of the modes are computed from their SATD costs as follows:

$$weight 1 = costMode 2 / ( costMode 1 + costMode 2 )$$

$$weight 2 = 1 - weight 1.$$

### Intra Sub-Partitions (ISP)

The intra sub-partitions (ISP) divides luma intra-predicted blocks vertically or horizontally into 2 or 4 sub-partitions depending on the block size. For each sub-partition, reconstructed samples are obtained by adding the residual signal to the prediction signal. Here, a residual signal is generated by the processes such as entropy decoding, inverse quantization and inverse transform. Therefore, the reconstructed sample values of each sub-partition are available to generate the prediction of the next sub-partition, and each sub-partition is processed repeatedly. In addition, the first sub-partition to be processed is the one containing the top-left sample of the CU and then continuing downwards (horizontal split) or rightwards (vertical split). As a result, reference samples used to generate the sub-partitions prediction signals are only located at the left and above sides of the lines. All sub-partitions share the same intra mode.

### Template Matching Prediction (TMP)

In JVET-V0130 and JVET-U0048, Template Matching Prediction (TMP) is disclosed. TMP is a special intra prediction mode that copies the best prediction block from the reconstructed part of the current frame, whose L-shaped template matches the current template. This is illustrated in FIG. 5, where block 510 is a current block and block 520 is a prediction block. For a predefined search range 530, the encoder searches for the most similar template 522 to the current template 512 in the reconstructed part 550 of the current frame 540, and uses the corresponding block 520 as a prediction block (as a reference block). The encoder then signals the usage of this mode, and the inverse operation is made at the decoder side.

### Chroma Intra Mode Coding

Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the centre position of the current chroma block is directly inherited.

### An Extrapolation Filter-Based Intra Prediction (EIP) Mode

In JVET-AF0080 (Luhang Xu, et al., “EE2-2.7: An extrapolation filter-based intra prediction mode”, Joint Video Experts Team (JVET) of ITU-T SG 16 WP 3 and ISO/IEC JTC 1/SC 29, 32nd Meeting, Hannover, DE, 13-20 Oct. 2023, Document: JVET-AF0080), the extrapolation filter-based intra prediction is disclosed, where the EIP prediction is performed in three steps. First, the extrapolation filter coefficients are derived from a neighbouring reconstructed area of the current block or inherited from a previous EIP block. Second, the extrapolation process generates predicted signals from the top-left to bottom-right corner within the current block. Third, an intra prediction 35 angle is derived by analyzing the gradient of the predicted block, and then the corresponding intra-mode is used to select the MTS (Multiple Transform Selection), NSPT (Non-Separable Primary Transform) and LFNST (Low Frequency Non-Separable Transform) kernel for transformation.

### Obtaining the EIP Filter

The three EIP filter shapes are shown in FIG. 6, where the three filter shapes correspond to square 610, horizontal strip 620, and vertical strip 630.

There are two ways to obtain the filter coefficients for the current CU according to JVET-AF0080. First, the coefficients can be derived from the neighbouring reconstructed pixels, and second, they can also be inherited from the previously decoded blocks.

### Derivation of EIP Coefficients

The decoder decodes the relevant syntax elements to determine the selected type of reconstructed area and the filter shape for the current block. The selected filter moves in the selected reconstructed area either horizontally or vertically with a one-pixel step to construct the auto-correlation matrix and the cross-correlation vector. The calculation of coefficients from the auto-correlation matrix and the cross-correlation vector is the same as that in convolutional cross-component model (CCCM).

The three types of the reconstructed area are defined as shown in FIG. 7, where the three reconstructed areas correspond to Left-Above area (FIG. 7A), Above area (FIG. 7B), and Left area (FIG. 7C). The size of the reconstructed area depends on the min (block Width, blockHeight) and the selected filter shape. For example, when the current block is an 8×16 block and the selected filter shape is 4×4. The aboveSize of the reconstructed area is equal to min (8, 16)+4−1=11, and the leftSize of the reconstructed area is equal to min (8, 16)+4−1=11.

### Inheritance of the EIP Filters

The EIP merge mode is also disclosed in JVET-AF0080. The filter shape and the filter coefficients can be inherited from the previous decoded blocks with EIP or EIP merge mode.

### Prediction of the Current Block

The EIP mode generates prediction values for the current block from the top-left position to the bottom-right position by a diagonal prediction order, as shown in FIG. 8.

The calculation for the prediction values in JVET-AF0080 is shown as follows,

$${pred}_{( x , y )} = {\sum }_{i = 0}^{14} ( {c}_{i} \times {t}_{( x - {offsetX}_{i} , y - {offsetY}_{i} )} )$$

where pred_{(x,y)} is the predicted value at (x, y) in the current block, cᵢ is the i^{th} coefficient of the selected EIP filter, the index of the coefficients is from 0 to 14, t_{(x-offsetX}_{ᵢ}_{,y-offsetY}_{ᵢ}₎ is a reconstructed or a predicted value used for the current position's prediction. offsetXᵢ and offsetYᵢ are the position offsets to the current position along x and y directions, respectively.

### Enhanced MTS for Intra Coding

In the current VVC design, for MTS, only DST7 and DCT8 transform kernels are utilized which are used for intra and inter coding.

Additional primary transforms including DCT5, DST4, DST1, and identity transform (IDT) are employed. Also MTS set is made dependent on the TU size and intra mode information. For blocks predicted via IntraTMP (Intra Template Matching Prediction), DIMD process is used on the prediction block to derive an intra mode that is used for transform selection. Specifically, a horizontal gradient and a vertical gradient are calculated for each predicted sample to build a HoG. Then the intra prediction mode with the largest histogram amplitude value is used to the MTS transform set.

Secondary Transformation: LFNST Extension with Large Kernel

The LFNST design in VVC is extended as follows:
The number of LFNST sets(S) and candidates (C) are extended to S=35 and C=3, and the LFNST set (lfnstTrSetIdx) for a given intra mode (predModeIntra) is derived according to the following formula:

$$For predModeIntra < 2 , lfnstTrSetIdx is equal to 2$$

$$lfnstTrSetIdx = predModeIntra , for predModeIntra in [ 0 , 34 ]$$

$$lfnstTrSetIdx = 68 - predModeIntra , for prefModeIntra in [ 35 , 66 ]$$

Three different kernels, LFNST4, LFNST8, and LFNST16, are defined to indicate LFNST kernel sets, which are applied to 4×N/N×4 (N≥4), 8×N/N×8 (N≥8), and M×N (M, N≥16), respectively.

The mapping from intra prediction modes to these sets is shown in Table 1.

TABLE 1
Mapping of intra prediction modes to LFNST set index

| Intra pred. mode | −14 | −13 | −12 | −11 | −10 | −9 | −8 | −7 | −6 | −5 | −4 | −3 | −2 | −1 | 0 | 1 |
|---|---|---|---|---|---|---|---|---|---|---|---|---|---|---|---|---|
| LFNST set index | 2 | 2 | 2 | 2 | 2 | 2 | 2 | 2 | 2 | 2 | 2 | 2 | 2 | 2 | 0 | 1 |

| Intra pred. mode | 2 | 3 | 4 | 5 | 6 | 7 | 8 | 9 | 10 | 11 | 12 | 13 | 14 | 15 | 16 | 17 |
|---|---|---|---|---|---|---|---|---|---|---|---|---|---|---|---|---|
| LFNST set index | 2 | 3 | 4 | 5 | 6 | 7 | 8 | 9 | 10 | 11 | 12 | 13 | 14 | 15 | 16 | 17 |
| Intra pred. mode | 18 | 19 | 20 | 21 | 22 | 23 | 24 | 25 | 26 | 27 | 28 | 29 | 30 | 31 | 32 | 33 |
| LFNST set index | 18 | 19 | 20 | 21 | 22 | 23 | 24 | 25 | 26 | 27 | 28 | 29 | 30 | 31 | 32 | 33 |
| Intra pred. mode | 34 | 35 | 36 | 37 | 38 | 39 | 40 | 41 | 42 | 43 | 44 | 45 | 46 | 47 | 48 | 49 |
| LFNST set index | 34 | 33 | 32 | 31 | 30 | 29 | 28 | 27 | 26 | 25 | 24 | 23 | 22 | 21 | 20 | 19 |
| Intra pred. mode | 50 | 51 | 52 | 53 | 54 | 55 | 56 | 57 | 58 | 59 | 60 | 61 | 62 | 63 | 64 | 65 |
| LFNST set index | 18 | 17 | 16 | 15 | 14 | 13 | 12 | 11 | 10 | 9 | 8 | 7 | 6 | 5 | 4 | 3 |

| Intra pred. mode | 66 | 67 | 68 | 69 | 70 | 71 | 72 | 73 | 74 | 75 | 76 | 77 | 78 | 79 | 80 |
|---|---|---|---|---|---|---|---|---|---|---|---|---|---|---|---|
| LFNST set index | 2 | 2 | 2 | 2 | 2 | 2 | 2 | 2 | 2 | 2 | 2 | 2 | 2 | 2 | 2 |

For blocks using MIP (Matrix-based Intra Prediction) or IntraTMP prediction, the LENST set index is derived as follows. DIMD is used to derive the intra prediction mode of the current block based on the MIP or IntraTMP predicted samples.

### Non-Separable Primary Transform (NSPT) for Intra Coding

The separable DCT-II plus LFNST transform combinations are replaced by NSPT for the block shapes 4×4, 4×8, 8×4 and 8×8, 4×16, 16×4, 8×16 and 16×8.

All NSPTs consist of 35 sets and 3 candidates (similar to the current LFNST). The kernels of NSPTs have the following shapes:

$$NSPT 4 \times 4 : 16 \times 16$$

$$NSPT 4 \times 8 / NSPT 8 \times 4 : 32 \times 20$$

$$NSPT 8 \times 8 : 64 \times 32$$

$$NSPT 4 \times 16 / NSPT 16 \times 4 : 64 \times 24$$

$$NSPT 8 \times 16 / NSPT 16 \times 8 : 128 \times 40$$

$$NSPT 4 \times 32 / NSPT 32 \times 4 : 128 \times 20$$

$$NSPT 8 \times 32 / NSPT 32 \times 8 : 256 \times 24$$

Therefore, 12, 32, 40 and 88 coefficients are zeroed-out using NSPT4×8/NSPT8×4, NSPT8×8, NSPT4×16/NSPT16×4 and NSPT8×16/NSPT16×8 respectively. For NSPT4×32/NSPT32×4 and NSPT8×32/NSPT32×8, remaining 108 and 232 positions in each transform block are zeroed-out, respectively.

### Inter Prediction Overview

According to JVET-T2002. (Jianle Chen, et. al., “Algorithm description for Versatile Video Coding and Test Model 11 (VTM 11)”, Joint Video Experts Team (JVET) of ITU-T SG 16 WP 3 and ISO/IEC JTC 1/SC 29, 20th Meeting, by teleconference, 7-16 Oct. 2020, Document: JVET-T2002)), for each inter-predicted CU, motion parameters consist of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU, which are obtained from neighbouring CUs, including spatial and temporal candidates, and additional schedules introduced in VVC. The merge mode can be applied to any inter-predicted CU, not only for skip mode. The alternative to the merge mode is the explicit transmission of motion parameters, where motion vector, corresponding reference picture index for each reference picture list and reference picture list usage flag and other needed information are signalled explicitly per each CU.

Beyond the inter coding features in HEVC, VVC includes a number of new and refined inter prediction coding tools listed as follows:
Extended merge prediction
Merge mode with MVD (MMVD)
Symmetric MVD (SMVD) signalling
Affine motion compensated prediction
Subblock-based Temporal Motion Vector Prediction (SbTMVP)
Adaptive motion vector resolution (AMVR)
Motion field storage: 1/16^{th} luma sample MV storage and 8×8 motion field compression
Bi-prediction with CU-level weight (BCW)
Bi-directional optical flow (BDOF)
Decoder side motion vector refinement (DMVR)
Geometric partitioning mode (GPM)
Combined inter and intra prediction (CIIP)

The following description provides the details of those inter prediction methods specified in VVC.

### Extended Merge Prediction

In VVC, the merge candidate list is constructed by including the following five types of candidates in order:
1) Spatial MVP from spatial neighbour CUs
2) Temporal MVP from collocated CUs
3) History-based MVP from an FIFO table
4) Pairwise average MVP
5) Zero MVs.

The size of merge list is signalled in sequence parameter set (SPS) header and the maximum allowed size of merge list is 6. For each CU coded in the merge mode, an index of best merge candidate is encoded using truncated unary binarization (TU). The first bin of the merge index is coded with context and bypass coding is used for remaining bins.

The derivation process of each category of the merge candidates is provided. As done in HEVC, VVC also supports parallel derivation of the merge candidate lists (or called as merging candidate lists) for all CUs within a certain size of area.

### Spatial Candidate Derivation

The derivation of spatial merge candidates in VVC is the same as that in HEVC except that the positions of first two merge candidates are swapped. A maximum of four merge candidates (B₀, A₀, B₁ and A₁) for current CU 910 are selected among candidates located in the positions depicted in FIG. 9. The order of derivation is B₀, A₀, B₁, A₁ and B₂. Position B₂ is considered only when one or more neighbouring CU of positions B₀, A₀, B₁, A₁ are not available (e.g., belonging to another slice or tile) or is intra coded.

### Temporal Candidates Derivation

In this step, only one candidate is added to the list. Particularly, in the derivation of this temporal merge candidate for a current CU 1010, a scaled motion vector is derived based on the co-located CU 1020 belonging to the collocated reference picture as shown in FIG. 10. The reference picture list and the reference index to be used for the derivation of the co-located CU is explicitly signalled in the slice header. The scaled motion vector 1030 for the temporal merge candidate is obtained as illustrated by the dotted line in FIG. 10, which is scaled from the motion vector 1040 of the co-located CU using the POC (Picture Order Count) distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

### History-Based Merge Candidate Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

Merge Mode with MVD (MMVD)

In addition to the merge mode, where the implicitly derived motion information is directly used for prediction samples generation of the current CU, the merge mode with motion vector differences (MMVD) is introduced in VVC. A MMVD flag is signalled right after sending a regular merge flag to specify whether MMVD mode is used for a CU.

In MMVD, after a merge candidate is selected (referred as a base merge candidate in this disclosure), it is further refined by the signalled MVDs information. The further information includes a merge candidate flag, an index to specify motion magnitude, and an index for indication of motion direction. In MMVD mode, one for the first two candidates in the merge list is selected to be used as MV basis. The MMVD candidate flag is signalled to specify which one is used between the first and second merge candidates.

Distance index specifies motion magnitude information and indicates the pre-defined offset from the starting points (1112 and 1122) for a L0 reference block 1110 and L1 reference block 1120. As shown in FIG. 11, an offset is added to either horizontal component or vertical component of the starting MV, where small circles in different styles correspond to different offsets from the centre. The relation of distance index and pre-defined offset is specified in Table 2.

TABLE 2
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent the four directions as shown in Table 3.

TABLE 3
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

### Affine Motion Compensated Prediction

In HEVC, only translation motion model is applied for motion compensation prediction (MCP). While in the real world, there are many kinds of motion, e.g. zoom in/out, rotation, perspective motions and the other irregular motions. In VVC, a block-based affine transform motion compensation prediction is applied. As shown in FIGS. 12A-B, the affine motion field of the block 1210 is described by motion information of two control point motion vectors (4-parameter) in FIG. 12A or three control point motion vectors (6-parameter) in FIG. 12B.

For 4-parameter affine motion model, motion vector at sample location (x, y) in a block is derived as:

$$\{ \begin{matrix}m {v}_{x} = \frac{m {v}_{1 x} - m {v}_{0 x}}{W} x - \frac{m {v}_{1 y} - m {v}_{0 y}}{W} y + m {v}_{0 x} \\ m {v}_{y} = \frac{m {v}_{1 y} - m {v}_{0 y}}{W} x + \frac{m {v}_{1 x} - m {v}_{0 x}}{W} y + m {v}_{0 y}\end{matrix} \qquad ( 3 )$$

For 6-parameter affine motion model, motion vector at sample location (x, y) in a block is derived as:

$$\{ \begin{matrix}m {v}_{x} = \frac{m {v}_{1 x} - m {v}_{0 x}}{W} x + \frac{m {v}_{2 x} - m {v}_{0 x}}{H} y + m {v}_{0 x} \\ m {v}_{y} = \frac{m {v}_{1 y} - m {v}_{0 y}}{W} x + \frac{m {v}_{2 y} - m {v}_{0 y}}{H} y + m {v}_{0 y}\end{matrix} \qquad ( 4 )$$

Where (mv₀ₓ, mv_{0y}) is motion vector of the top-left corner control point, (mv₁ₓ, mv_{1y}) is motion vector of the top-right corner control point, and (mv₂ₓ, mv_{2y}) is motion vector of the bottom-left corner control point.

In order to simplify the motion compensation prediction, block based affine transform prediction is applied. To derive motion vector of each 4×4 luma subblock, the motion vector of the centre sample of each subblock, as shown in FIG. 13, is calculated according to above equations, and rounded to 1/16 fraction accuracy. Then, the motion compensation interpolation filters are applied to generate the prediction of each subblock with the derived motion vector. The subblock size of chroma-components is also set to be 4×4. The MV of a 4×4 chroma subblock is calculated as the average of the MVs of the top-left and bottom-right luma subblocks in the collocated 8×8 luma region.

As is for translational-motion inter prediction, there are also two affine motion inter prediction modes: affine merge mode and affine AMVP (advanced MVP) mode.

### Affine Merge Prediction

AFFINE_MERGE mode can be applied for CUs with both width and height larger than or equal to 8. In this mode, the CPMVs (Control Point MVs) of the current CU is generated based on the motion information of the spatial neighbouring CUs. There can be up to five CPMVP (Control Point MVP) candidates and an index is signalled to indicate the one to be used for the current CU. The following three types of CPMVP candidate are used to form the affine merge candidate list:
Inherited affine merge candidates that are extrapolated from the CPMVs of the neighbour CUs
Constructed affine merge candidates CPMVPs that are derived using the translational MVs of the neighbour CUs
Zero MVs

In VVC, there are two inherited affine candidates at most, which are derived from the affine motion model of the neighbouring blocks, one from left neighbouring CUs and one from above neighbouring CUs. The candidate blocks are the same as those shown in FIG. 9. For the left predictor, the scan order is A₀->A₁, and for the above predictor, the scan order is B₀->B₁->B₂. Only the first inherited candidate from each side is selected. No pruning check is performed between two inherited candidates. When a neighbouring affine CU is identified, its control point motion vectors are used to derived the CPMVP candidate in the affine merge list of the current CU. As shown in FIG. 14, if the neighbouring left bottom block A of the current block 1410 is coded in affine mode, the motion vectors v₂, v₃ and v₄ of the top left corner, above right corner and left bottom corner of the CU 1420 containing block A are attained. When block A is coded with 4-parameter affine model, the two CPMVs of the current CU (i.e., v₀ and v₁) are calculated according to v₂, and v₃. In case that block A is coded with 6-parameter affine model, the three CPMVs of the current CU are calculated according to v₂, v₃ and v₄.

Constructed affine candidate means the candidate is constructed by combining the neighbouring translational motion information of each control point. The motion information for the control points is derived from the specified spatial neighbours and temporal neighbour for a current block 1510 as shown in FIG. 15. CPMVₖ (k=1, 2, 3, 4) represents the k-th control point. For CPMV₁, the B2->B3->A2 blocks are checked and the MV of the first available block is used. For CPMV₂, the B1->B0 blocks are checked and for CPMV₃, the A1->A0 blocks are checked. For CPMV₄, TMVP is used as CPMV₄ if it's available.

After MVs of four control points are attained, affine merge candidates are constructed based on the motion information. The following combinations of control point MVs are used to construct in order:
{CPMV₁, CPMV₂, CPMV₃}, {CPMV₁, CPMV₂, CPMV₄}, {CPMV₁, CPMV₃, CPMV₄}, {CPMV₂, CPMV₃, CPMV₄}, {CPMV₁, CPMV₂}, {CPMV₁, CPMV₃}

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

After inherited affine merge candidates and constructed affine merge candidate are checked, if the list is still not full, zero MVs are inserted to the end of the list.

### Affine AMVP Prediction

Affine AMVP mode can be applied for CUs with both width and height larger than or equal to 16. An affine flag in the CU level is signalled in the bitstream to indicate whether affine AMVP mode is used and then another flag is signalled to indicate whether 4-parameter affine or 6-parameter affine is used. In this mode, the difference of the CPMVs of current CU and their predictors CPMVPs is signalled in the bitstream. The affine AMVP candidate list size is 2 and it is generated by using the following four types of CPMVP candidate in order:
Inherited affine AMVP candidates that extrapolated from the CPMVs of the neighbour CUs
Constructed affine AMVP candidates CPMVPs that are derived using the translational MVs of the neighbour CUs
Translational MVs from neighbouring CUs
Zero MVs

### Geometric Partitioning Mode (GPM)

In VVC, a Geometric Partitioning Mode (GPM) is supported for inter prediction. The geometric partitioning mode is signalled using a CU-level flag as one kind of merge mode, with other merge modes including the regular merge mode, the MMVD mode, the CIIP mode and the subblock merge mode. A total of 64 partitions are supported by geometric partitioning mode for each possible CU size, w×h=2^{m}×2ⁿ with m, n∈{3 . . . 6} excluding 8×64 and 64×8.

When this mode is used, a CU is split into two parts by a geometrically located straight line in certain angles. The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that only two motion compensated prediction are needed for each CU, same as the conventional bi-prediction. The uni-prediction motion for each partition is derived.

If geometric partitioning mode is used for the current CU, then a geometric partition index indicating the selected partition mode of the geometric partition (angle and offset), and two merge indices (one for each partition) are further signalled. The number of maximum GPM candidate size is signalled explicitly in SPS (Sequence Parameter Set) and specifies syntax binarization for GPM merge indices. After predicting each of part of the geometric partition, the sample values along the geometric partition edge are adjusted using a blending processing with adaptive weights. This is the prediction signal for the whole CU, and transform and quantization process will be applied to the whole CU as in other prediction modes. Finally, the motion field of a CU predicted using the geometric partition modes is stored.

### Combined Inter and Intra Prediction (CIIP)

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pᵢₙₜₑᵣ is derived using the same inter prediction process applied to regular merge mode; and the intra prediction signal Pᵢₙₜᵣₐ is derived following the regular intra prediction process with the planar mode. Then, the intra and inter prediction signals are combined using weighted averaging, where the weight value wt is calculated depending on the coding modes of the top and left neighbouring blocks (as shown in FIG. 16) of current CU 1610 as follows:
If the top neighbour is available and intra coded, then set isIntraTop to 1, otherwise set isIntraTop to 0;
If the left neighbour is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is formed as follows:

$${P}_{CIIP} = ( ( 4 - w t ) * {P}_{inter} + w t * {P}_{intra} + 2 ) ≫ 2$$

### GPM Extension

At the JVET-V meeting, several variations were proposed to improve the coding efficiency of the GPM mode in the VVC. The methods were included in the exploration experiment (EE2) for further evaluations, the main technical aspects of which are described as follows:

EE2-3.3 on GPM with MMVD (GPM-MMVD): 1) additional MVDs are added to the existing GPM merge candidates; 2) the MVDs are signalled in the same manner as the MMVD in the VVC, i.e., one distance index plus one direction index; 3) two flags are signalled to separately control whether the MMVD is applied to each GPM partition or not.

EE2-3.4-3.5 on GPM with template matching (GPM-TM): 1) template matching is extended to the GPM mode by refining the GPM MVs based on the left and above neighbouring samples of the current CU; 2) the template samples are selected dependent on the GPM split direction; 3) one single flag is signalled to jointly control whether the template matching is applied to the MVs of two GPM partitions or not.

In JVET-Y0065 (Yoshitaka Kidani, et. al., “EE2-3.1: GPM with inter and intra prediction (JVET-X0166)”, Joint Video Experts Team (JVET) of ITU-T SG 16 WP 3 and ISO/IEC JTC 1/SC 29, 25th Meeting, by teleconference, 12-21 Jan. 2022, Document: JVET-Y0065), in GPM with inter and intra prediction (or named GPM intra or GPM-intra), the final prediction samples are generated by weighting inter predicted samples and intra predicted samples for each GPM-separated region. The inter predicted samples are derived by the same scheme as the GPM in the current Enhanced Compression Model (ECM) whereas the intra predicted samples are derived by an intra prediction mode (IPM) candidate list and an index signalled from the encoder. The IPM candidate list size is pre-defined as 3. The available IPM candidates are the parallel angular mode against the GPM block boundary (Parallel mode), the perpendicular angular mode against the GPM block boundary (Perpendicular mode), and the Planar mode as shown in FIGS. 17A-C, respectively. Furthermore, GPM with intra and intra prediction as shown in FIG. 17D is restricted in the proposed method to reduce the signalling overhead for IPMs and avoid an increase in the size of the intra prediction circuit on the hardware decoder. In addition, a direct motion vector and IPM storage on the GPM-blending area is introduced to further improve the coding performance.

### Non-Adjacent Spatial Candidate

The non-adjacent spatial merge candidates as in JVET-L0399 (Yu Han, et al., “CE4.4.6: Improvement on Merge/Skip mode”, Joint Video Exploration Team (JVET) of ITU-T SG 16 WP 3 and ISO/IEC JTC 1/SC 29/WG 11, 12th Meeting: Macao, CN, 3-12 Oct. 2018, Document: JVET-L0399) are inserted after the TMVP in the regular merge candidate list. The pattern of spatial merge candidates is shown in FIG. 18. The distances between non-adjacent spatial candidates and current coding block are based on the width and height of current coding block. The line buffer restriction is not applied.

### Template Matching for MV Refinement

Template matching (TM) is a decoder-side MV derivation method to refine the motion information of the current CU by finding the closest match between a template (i.e., top 1914 and/or left 1916 neighbouring blocks of the current CU 1912) in the current picture 1910 and a block (i.e., same size to the template, block 1924 and 1926) in a reference picture 1920 as shown in FIG. 19. In FIG. 19, a better MV is searched around the initial motion 1930 of the current CU 1912 of the current picture 1910 within a [−8, +8]-pel search range 1922 around location 1928 in the reference picture 1920 as pointed by the initial MV 1930.

Adaptive Reordering of Merge Candidates with Template Matching (ARMC-TM)

The merge candidates are adaptively reordered according to costs evaluated using template matching (TM). The reordering method can be applied to the regular merge mode, template matching (TM) merge mode, and affine merge mode (excluding the SbTMVP candidate). For the TM merge mode, merge candidates are reordered before the refinement process.

The template matching cost of a merge candidate during the reordering process is measured by the SAD between samples of a template of the current block and their corresponding reference samples. The template comprises a set of reconstructed samples neighbouring to the current block. Reference samples of the template are located by the motion information of the merge candidate. When a merge candidate utilizes bi-directional prediction, the reference samples of the template of the merge candidate are also generated by bi-prediction as shown in FIG. 20. In FIG. 20, block 2012 corresponds to a current block in current picture 2010, blocks 2022 and 2032 correspond to reference blocks in reference pictures 2020 and 2030 in list 0 and list 1 respectively. Templates 2014 and 2016 are for current block 2012, templates 2024 and 2026 are for reference block 2022, and templates 2034 and 2036 are for reference block 2032. Motion vectors 2040, 2042 and 2044 of the merge candidate are in list 0 and motion vectors 2060, 2062 and 2064 of the merge candidate are in list 1.

For subblock-based merge candidates with subblock size equal to Wsub×Hsub, the above template comprises several sub-templates with the size of Wsub×1, and the left template comprises several sub-templates with the size of 1×Hsub. As shown in FIG. 21, the motion information of the subblocks in the first row and the first column of current block is used to derive the reference samples of each sub-template. In FIG. 21, block 2112 corresponds to a current block in current picture 2110 and block 2122 corresponds to a collocated block in reference picture 2120. Each small square in the current block and the collocated block corresponds to a subblock. The dot-filled areas on the left and top of the current block correspond to template for the current block. The boundary subblocks are labelled from A to G. The arrow associated with each subblock corresponds to the motion vector of the subblock. The reference subblocks (labelled as Aref to Gref) are located according to the motion vectors associated with the boundary subblocks.

### Intra Block Copy (IBC)

Intra block copy (IBC) is a tool adopted in HEVC extensions on Screen Content Coding (SCC). It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. An IBC-coded CU is treated as the third prediction mode other than intra or inter prediction modes. The IBC mode is applicable to the CUs with both width and height smaller than or equal to 64 luma samples.

### Intra Template Matching

Intra template matching prediction (IntraTMP, similar to or same as TMP mentioned before) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

In the present invention, methods and apparatus to derive a combined predictor, where the inter prediction can refer to subblock-based prediction or GPM-related prediction are disclosed.

### BRIEF SUMMARY OF THE INVENTION

A method and apparatus for video coding are disclosed. According to the method, input data associated with a current block is received, wherein the input data comprise pixel data to be encoded at an encoder side or coded data associated with the current block to be decoded at a decoder side. Combined prediction comprising target inter prediction and at least one of target intra prediction and neighbouring reconstructed samples is determined, wherein the target inter prediction refers to subblock-based inter prediction or GPM (Geometric Partitioning Mode)-related prediction. The current block is encoded or decoded by using prediction data comprising the combined prediction.

In one embodiment, explicit signalling is used to indicate whether to use subblock-based CIIP (Combined inter and intra prediction) for the current block or to indicate whether to use GPM-based CIIP for the current block.

In one embodiment, the subblock-based inter prediction is generated using one or more subblock-based motion candidates from a subblock merge candidate list. In one embodiment, the subblock merge candidate list is unified with subblock merge candidates for affine and SbTMVP (Subblock-based Temporal Motion Vector Prediction) modes.

In one embodiment, subblock-based CIIP is supported for CIIP-TM (Template Matching), CIIP-PDPC (Position Dependent intra Prediction Combination), or both.

In one embodiment, the GPM-related prediction is generated using GPM-TM, GPM-MMVD (Merge mode with Motion Vector Differences), GPM-intra, or any combination or extension thereof.

In one embodiment, GPM-based CIIP is supported for CIIP-TM, CIIP-PDPC, or both.

In one embodiment, the combined prediction is formed by using said neighbouring reconstructed samples to blend with the target inter prediction.

In one embodiment, the target inter prediction is generated using one or more inter motion candidates being refined by template matching. In one embodiment, the said one or more inter motion candidates correspond to one or more merge candidates after said template matching.

In one embodiment, the target intra prediction and the target inter prediction are blended using blending weights and multiple blending methods with different weights are treated as multiple optional modes of combined prediction mode.

In one embodiment, one or more intra modes are determined using histogram analysis process. In one embodiment, said one or more intra modes corresponding to a largest histogram count is used to determine a transform set in transform process of the current block and/or a coding process of following coding blocks. In one embodiment, the transform process of the current block corresponds to LFNST (Low Frequency Non-Separable Transform), NSPT (Non-Separable Primary Transform), MTS (Multiple Transform Selection), or a combination thereof.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIGS. 2A-B illustrate the top reference with length 2W+1 and the left reference with length 2H+1 in order to support wide-angle prediction directions for a block with width much larger than height (FIG. 2A) and a block with height much larger than width (FIG. 2B).

FIG. 3A illustrates an example of selected template for a current block, where the template comprises T lines above the current block and T columns to the left of the current block.

FIG. 3B illustrates an example for T=3 and the HoG (Histogram of Gradient) is calculated for pixels in the middle line and pixels in the middle column.

FIG. 3C illustrates an example of the amplitudes (ampl) for the angular intra prediction modes.

FIG. 4 illustrates an example of template-based intra mode derivation (TIMD) mode, where TIMD implicitly derives the intra prediction mode of a CU using a neighbouring template at both the encoder and decoder.

FIG. 5 illustrates an example of Template Matching Prediction (TMP).

FIG. 6 illustrates three types of filter shapes with fifteen inputs and generate one output for EIP process.

FIGS. 7A-C illustrate three types (FIG. 7A: Left-Above area, FIG. 7B: Above area, and FIG. 7C: Left area) of reconstructed areas used to derive filter coefficients for EIP.

FIG. 8 illustrates an example of scanning order for generating predictions for different positions in the current block by a diagonal order.

FIG. 9 illustrates the neighbouring blocks used for deriving spatial merge candidates for VVC.

FIG. 10 illustrates an example of temporal candidate derivation, where a scaled motion vector is derived according to POC (Picture Order Count) distances.

FIG. 11 illustrates the distance offsets from a starting MV in the horizontal and vertical directions according to Merge Mode with MVD (MMVD).

FIG. 12A illustrates an example of the affine motion field of a block described by motion information of two control point motion vectors (4-parameter).

FIG. 12B illustrates an example of the affine motion field of a block described by motion information of three control point motion vectors (6-parameter).

FIG. 13 illustrates an example of block based affine transform prediction, where the motion vector of each 4×4 luma subblock is derived from the control-point MVs.

FIG. 14 illustrates an example of derivation for inherited affine candidates based on control-point MVs of a neighbouring block.

FIG. 15 illustrates an example of affine candidate construction by combining the translational motion information of each control point from spatial neighbours and temporal neighbour.

FIG. 16 illustrates an example of the weight value derivation for Combined Inter and Intra Prediction (CIIP) according to the coding modes of the top and left neighbouring blocks.

FIGS. 17A-C illustrate examples of available IPM candidates: the parallel angular mode against the GPM block boundary (Parallel mode, FIG. 17A), the perpendicular angular mode against the GPM block boundary (Perpendicular mode, FIG. 17B), and the Planar mode (FIG. 17C), and the intra and intra prediction (FIG. 17D) respectively.

FIG. 18 illustrates an exemplary pattern of the spatial merge candidates.

FIG. 19 illustrates an example of template matching used to refine an initial MV by searching a range around the initial MV.

FIG. 20 illustrates an example of templates used for the current block and corresponding reference blocks to measure matching costs associated with merge candidates.

FIG. 21 illustrates an example of template and reference samples of the template for block with sub-block motion using the motion information of the subblocks of the current block.

FIG. 22 illustrates an example of CIIP-PDPC according to one embodiment of the present invention.

FIG. 23 illustrates an example of the spatial neighbouring regions of the current block or the collocated block including above reference region, left reference region, and above-left reference region for deriving blending weights for combined prediction.

FIG. 24 illustrates a flowchart of an exemplary video coding system that derives combined prediction by using target inter prediction referring to subblock-based inter prediction or GPM (Geometric Partitioning Mode)-related prediction according to an embodiment of the present invention.

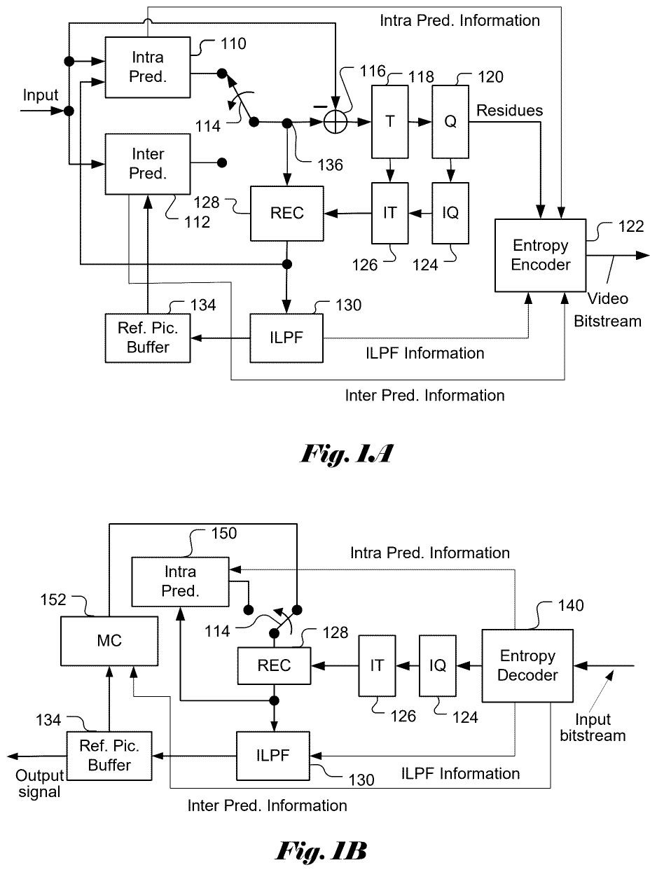

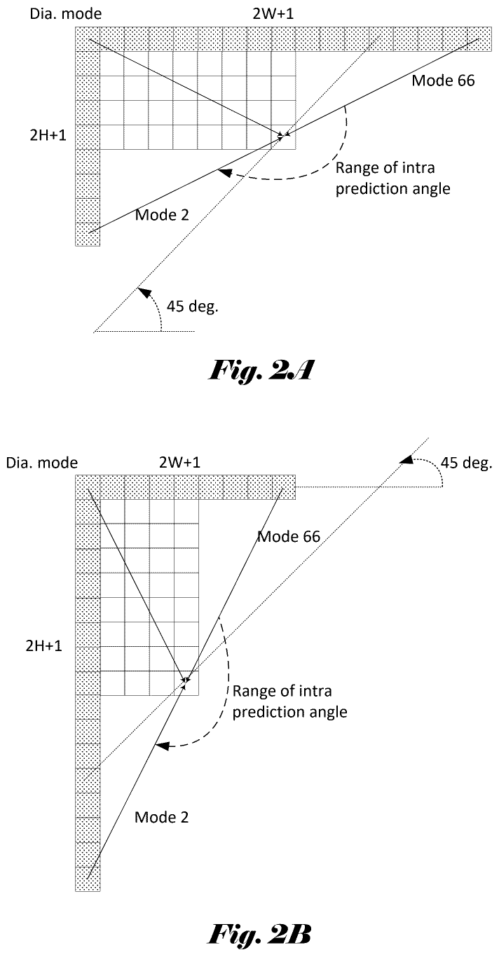

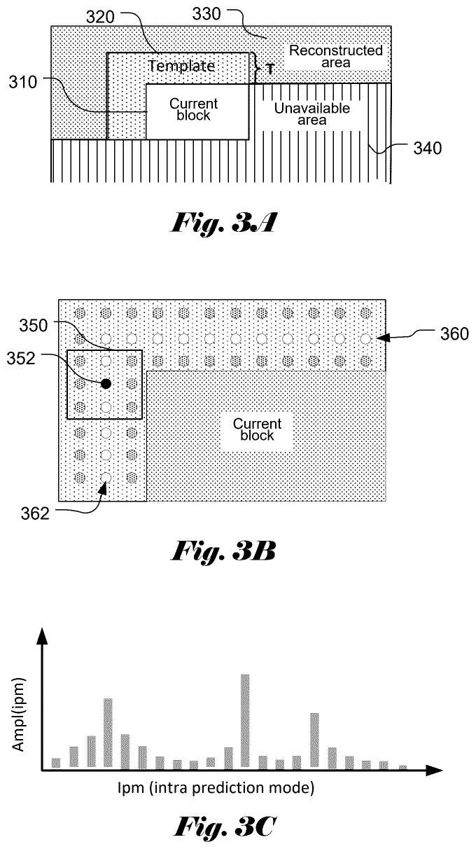

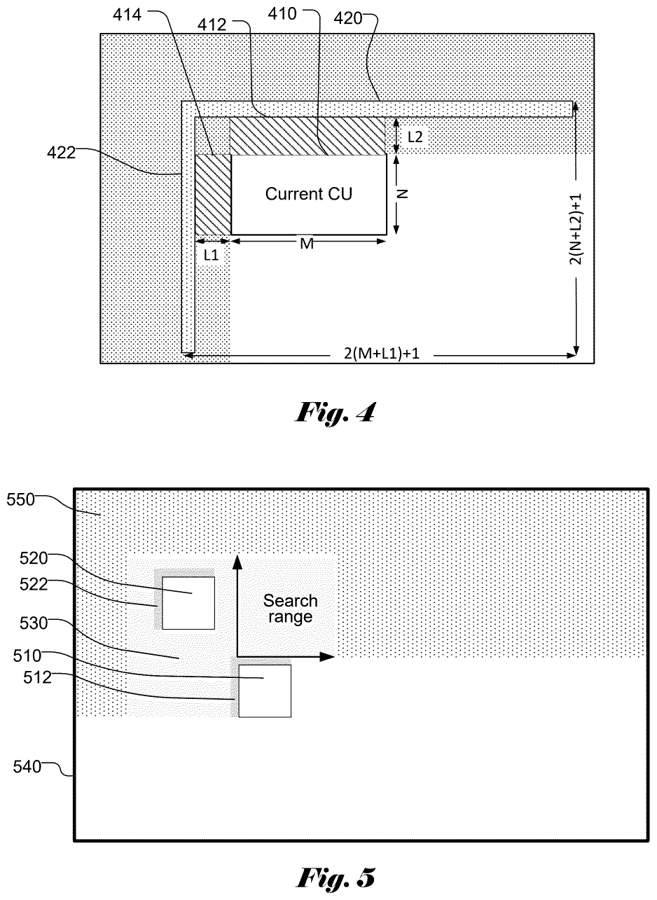

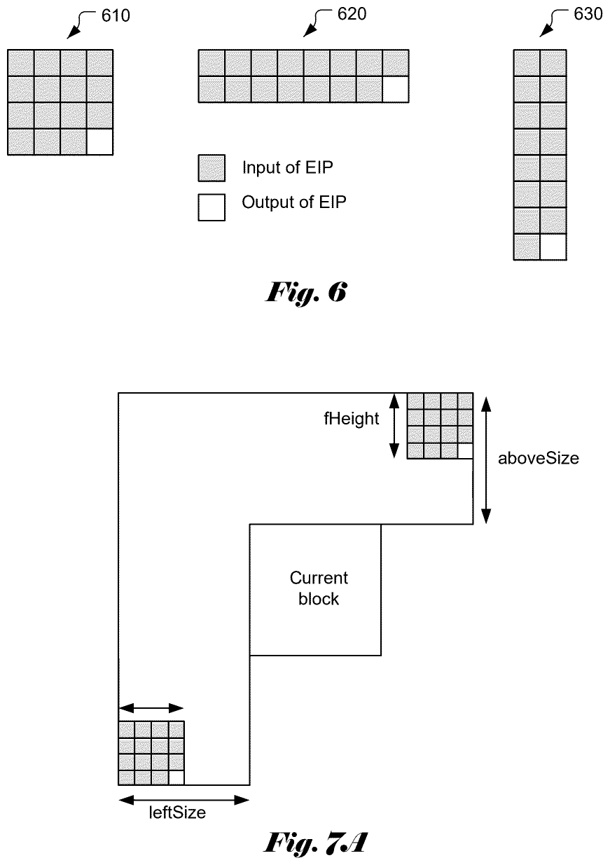

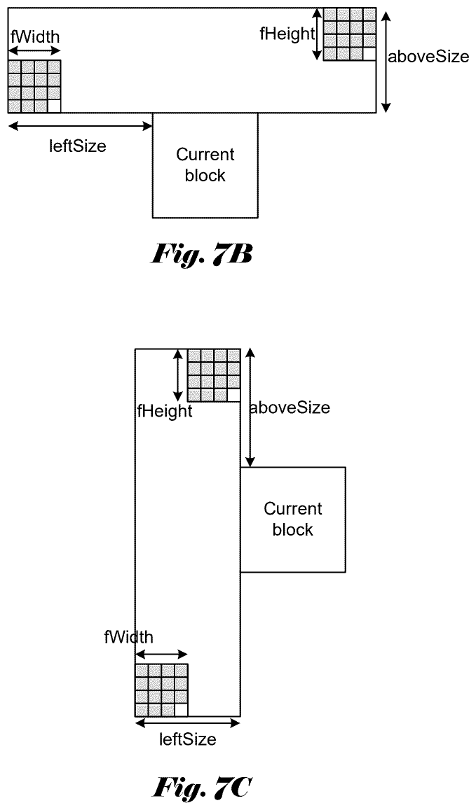

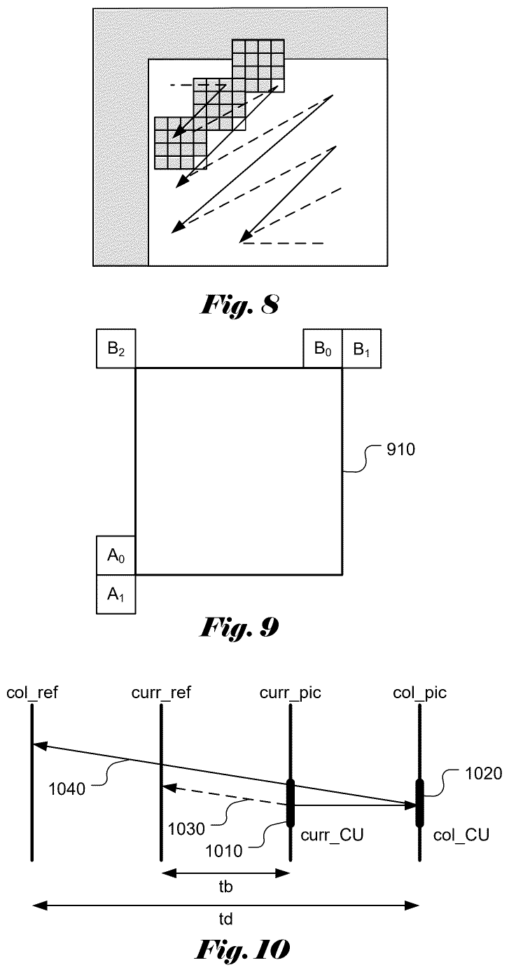

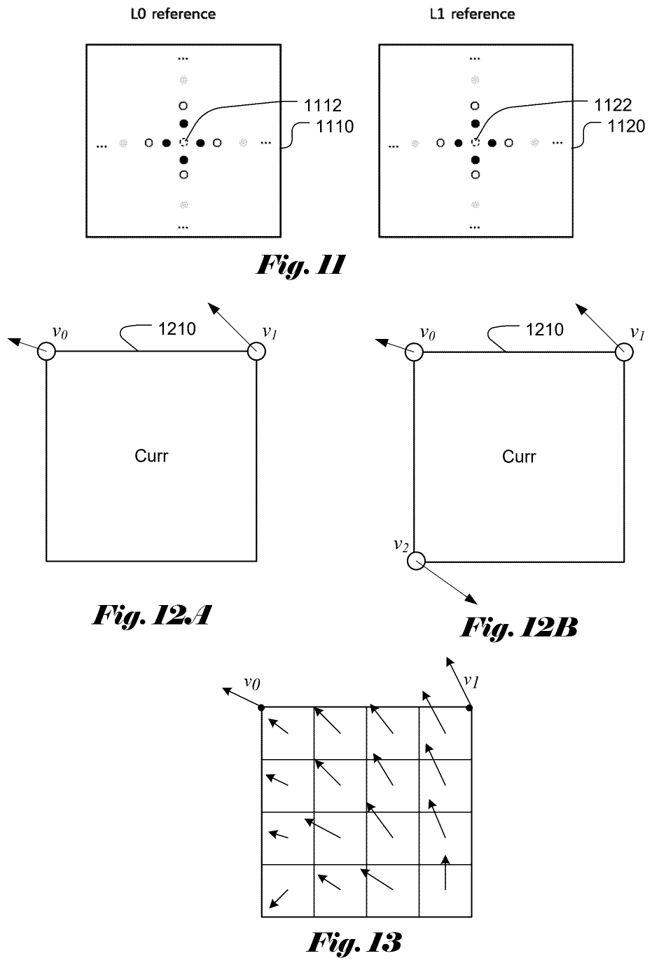

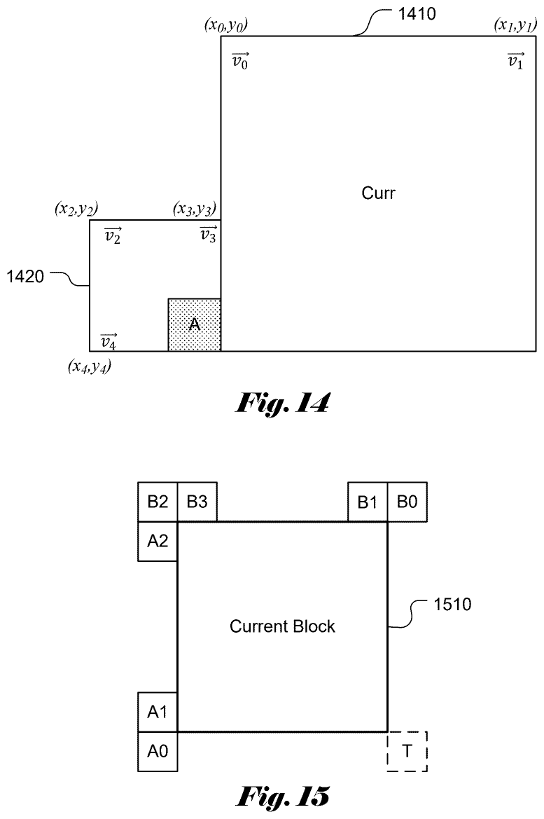

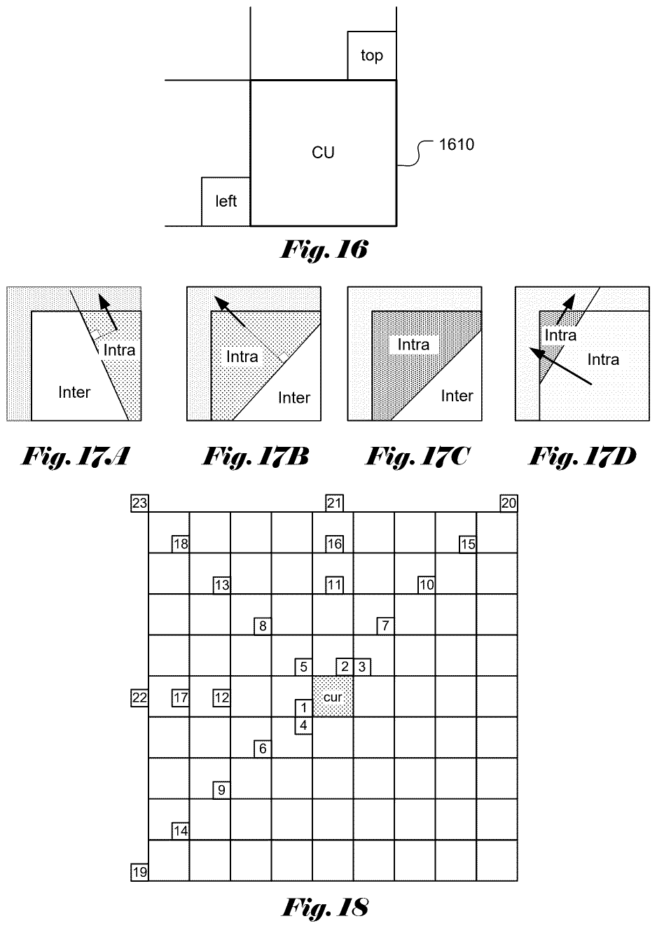

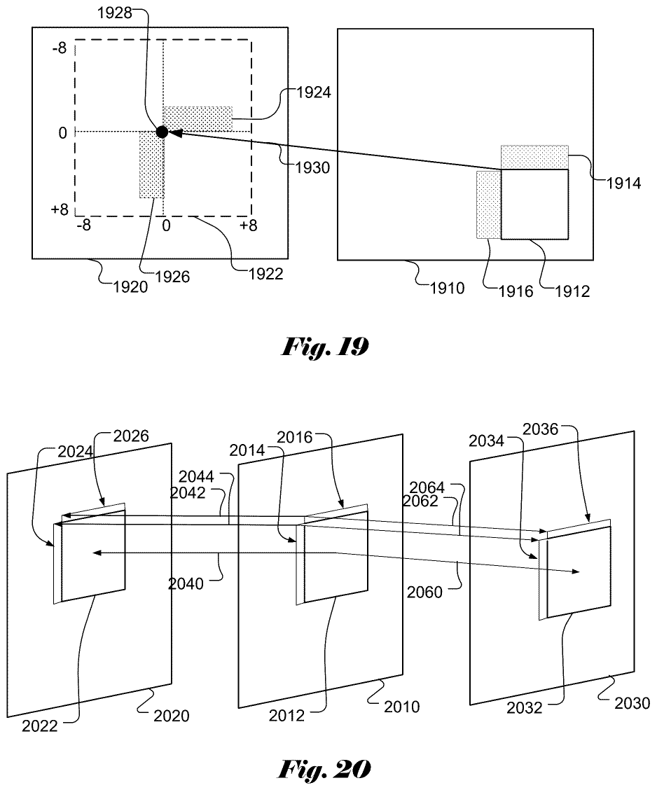

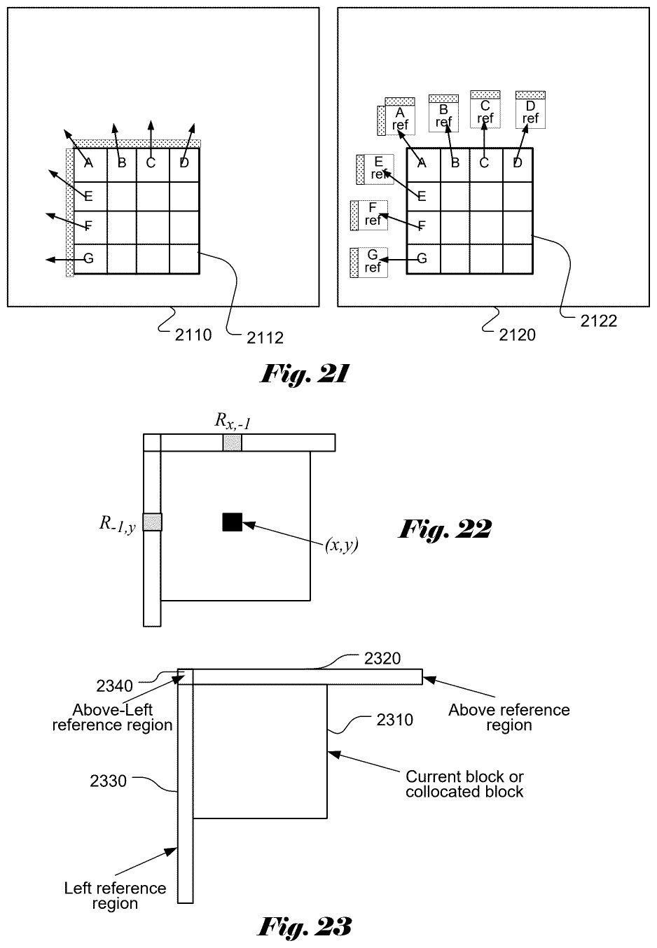

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In order to improve coding performance of CIIP, the inter prediction part is extended to refer to subblock-based inter prediction or GPM (Geometric Partitioning Mode)-related prediction.

In this invention, the following aspects are proposed to improve combined prediction which is formed by using a mode-type (e.g. intra) prediction and inter prediction with blending weighting. The combined prediction is called as CIIP in this invention. In one embodiment, the inter part of CIIP uses one or more regular inter motion candidates to generate inter prediction where the one or more inter motion candidates refer to regular merge candidates without template matching (TM). In another embodiment, the intra part of CIIP uses the intra prediction mode as TIMD to generate the intra predictors. For example, intra prediction predicted using TIMD derived intra prediction mode and/or the method is only applied to the block with an area less than or equal to a threshold (e.g. 1024). The TIMD derivation method is used to derive the intra prediction mode in CIIP. Specifically, the intra prediction mode with the smallest SATD value in the TIMD mode list is selected and mapped to one of the 67 regular intra prediction modes. In another embodiment (for CIIP-PDPC), the intra part of CIIP directly uses the neighbouring reconstructed samples to blend with the inter predictors and the blending weights depend on PDPC weighting. The PDPC weighting measures the distance between the current to-be-predicted sample position (x, y) and above corresponding neighbouring sample (R_{x, -1}) and/or the distance between the current to-be-predicted sample position (x, y) and left corresponding neighbouring sample (R_{-1, y}) as shown in FIG. 22. For example, the PDPC weighting (wT and wL) is calculated as follows:

$$w T = 32 ≫ ( ( y ≪ 1 ) ≫ nScale )$$

$$wL = 32 ≫ ( ( x ≪ 1 ) ≫ nScale )$$

$$nScale = ( floor Log 2 ( width ) + floor Log 2 ( height ) - 2 ) ≫ 2 ;$$

In this example, the combined prediction (Pred(x, y)) for each sample (x, y) is formed as follows.

$$Pred ( x , y ) = ( ( ( ( w T \times {R}_{x , - 1} + w L \times {R}_{- 1 , y} + 32 ) ≫ 6 ) ≪ 6 ) + ( 64 - w T - w L ) \times predInte r ( x , y ) + 32 ) ≫ 6$$

In another embodiment (for CIIP-TM which may be denoted as CIIP TM), the inter part of CIIP can be generated using one or more inter motion candidates which were refined by template matching. For example, the used inter merge candidate is a merge candidate after template matching (TM). In this case, the merge candidates for CIIP-TM are reordered by the ARMC method as regular non-CIIP merge candidates. The maximum number of CIIP-TM merge candidates is equal to two or any predefined positive integer. Different variations of CIIP can be treated as different optional modes of CIIP. For example, when the CIIP flag indicates to apply CIIP to the current block, additional syntax elements are signalled to indicate the selected variation of CIIP. A possible signalling method includes one flag (e.g. CIIP-PDPC flag) to indicate whether PDPC is used for the intra part of CIIP and/or the other flag (e.g. CIIP-TM flag) to indicate whether TM is used for the inter part of CIIP. One syntax case (e.g. CIIP-PDPC flag=true and CIIP TM flag=false) refers to use PDPC as the intra part of CIIP and regular inter motion candidate without TM as the inter part of CIIP. Another syntax case (e.g. CIIP-PDPC flag=false and CIIP TM flag=false) refers to using TIMD or a pre-defined regular intra prediction mode as the intra part of CIIP and regular inter motion candidate without TM as the inter part of CIIP. Another syntax case (e.g. CIIP-PDPC flag=true and CIIP TM flag=true) refers to using PDPC as the intra part of CIIP and the inter motion candidate with TM as the inter part of CIIP. Another syntax case (e.g. CIIP-PDPC flag=false and CIIP TM flag=true) refers to using TIMD or a pre-defined regular intra prediction mode as the intra part of CIIP and the inter motion candidate with TM as the inter part of CIIP.

In another embodiment, the mode-type prediction is generated using Extrapolation Filter-Based Intra Prediction (EIP). For example, the mode-type prediction is generated using any pre-defined mode in extrapolation filter-based intra prediction such as an EIP regular mode (i.e. non-merge EIP mode) with the EIP mode index equal to a pre-defined value, where the pre-defined value is fixed at 0 or adaptive according to the block position, block width, block height, and/or block area of the current block. For another example, the mode-type prediction is generated using any pre-defined mode in extrapolation filter-based intra prediction such as a EIP merge mode with the EIP merge index equal to a pre-defined value where the pre-defined value is fixed at 0 (i.e. the EIP merge mode at the front of the re-ordered or not-re-ordered EIP merge list) or adaptive according to the block position, block width, block height, and/or block area of the current block. In another embodiment, the mode-type prediction in the combined prediction is generated by the one or more prediction mode information suggested according to TIMD process.

Several aspects are proposed in the following. Aspect 1 (as shown in Section I) is related to the candidates list for suggestion for TIMD process. Aspect 2 (as shown in Section II) is related to how to generate the mode-type prediction according to the one or more prediction mode information from suggestion. Aspect 3 (as shown in Section III) is related to how to generate the inter prediction. Aspect 4 (as shown in Section IV) is related to the combined prediction and signalling. In another embodiment, the inter prediction here can be replaced with any pre-defined block-vector prediction if the proposed methods are applied to the target mode referring to IBC or intraTMP.

### I. Candidate List for Suggestion

The candidate list for TIMD is generated according to prediction mode information of the previous coded blocks and/or default prediction mode information. The prediction mode information includes or only includes mode-type, prediction mode, and/or any subset of above. In one embodiment, the candidate list here is aligned with the MPM list or any merge list for regular intra mode. For Example-1, the prediction mode information refers to the mode type equal to intra and the prediction mode equal to DC, PL, any directional mode, any intra prediction modes in the related art (i.e. WAIP or MIP), any intra prediction scheme in the standard (i.e. EIP including EIP regular modes, EIP merge modes, any subset/extension of the above-mentioned modes), or a combination thereof. For Example-2, the prediction mode information refers to the mode type equal to intraTMP and the prediction mode indicating block vectors obtained by searching in a pre-defined region using template matching. For Example-3, the prediction mode information refers to mode type equal to IBC and the prediction mode indicating block vectors. When (1) a previous coded block is available and (2) the mode-type and/or the prediction mode and/or any pre-defined prediction mode information of the previous coded block is supported by the mode using the proposed combining prediction, the prediction mode information of the previous coded block is valid and can be inserted into the candidate list here as a candidate. In one embodiment, all of Examples-1, Example-2, and Example-3 are supported by the mode using the proposed combined prediction. In another embodiment, any subset of Example-1, Example-2, and Example-3 are supported by the mode using the proposed combined prediction.

In another embodiment, the candidate list here can be any subset of the MPM list or any merge list for regular intra mode. That means the previous coded blocks checked in construction of MPM list or any merge list for regular intra mode will be checked in construction of the candidate list here. In another embodiment, the candidate list here which may refer to a merge candidate list, containing candidates with prediction mode information, is built for the current block. As what regular inter merge mode does, the merge candidate list includes the candidates of spatial adjacent candidates, non-adjacent candidates, history candidates, temporal candidates, default candidates, or any subset of above-mentioned candidates. The spatial adjacent candidates are from the adjacent neighbouring blocks of the current block where the adjacent neighbouring blocks can be the same as the 5 spatial neighbouring blocks for regular inter merge mode or any subset of the adjacent neighbouring blocks of the current block. The non-adjacent candidates are from a search range around (but not adjacent to) the current block. The search range can be the same as the search range of non-adjacent candidates for regular inter merge mode or different search range of the current block.

The history candidates are selected from a history-based buffer array. In the history-based buffer array, the prediction mode information of each valid previous coded block is stored where the valid previous coded block refers to any block containing supported prediction mode information (e.g. (1) information associated with mode type such as intraTMP, IBC, or a combination of above and/or information associated with prediction mode such as block vectors and/or (2) information associated with mode type as intra and/or information associated with prediction mode as EIP regular modes, EIP merge modes, or a combination of above). Like what history candidates in the merge list of regular inter merge mode, the first stored information may be removed for including the information associated with the latest valid coded block if the buffer array is full. The buffer array is cleaned up (or emptied) at the beginning or the end of a pre-defined unit. The pre-defined unit can be a CTU, CTU row, slice, tile, picture, or any pre-defined region. In one sub-embodiment, the merge candidate list refers to the history buffer array only. That is, only history candidates are included and/or will not use the candidates from a far non-adjacent region. The temporal candidates are obtained from the prediction mode information stored in one or more pre-defined previous coded picture if the stored information is valid. In one sub-embodiment, the temporal candidates are only available for inter slices which have the pre-defined previous coded picture as the collocated picture as the regular inter merge flow.

In one embodiment, the default candidates are the candidates containing default (valid) prediction mode information and/or derived according to the candidates already put in the merge candidate list. In another embodiment, the merge candidate list here is aligned with or can be any subset of the merge candidate list for regular inter merge mode. In another embodiment, full or partial pruning is used to avoid duplicated prediction mode information in the list. Before adding a candidate in the list, all or subset of prediction mode information of the to-be-added candidate is checked with the corresponding prediction mode information of all or any subset candidates already in the list. All prediction mode information refers to all stored prediction mode information (e.g. the mode type and/or prediction mode). The subset of prediction mode information can be only mode type or only prediction mode or any pre-defined subset from all.

### II. Generation of Mode-Type Prediction

The selection depends on implicitly or explicitly selecting one or more (K) candidates from the candidate list in Section I. After the selection, the one or more selected candidates are used to generate the mode-type prediction for the current block. If the mode types in Example-1, Example-2, and/or Example-3 are all supported and K>1, the mode type prediction can be intra (i.e. EIP)+intra (i.e. EIP), and/or intra (i.e. EIP)+intraTMP and/or intra (i.e. EIP)+IBC. If the mode types in Example-1, Example-2, and/or Example-3 are all supported and K=1, the mode type prediction can be intra (i.e. EIP), and/or intraTMP and/or IBC. In one embodiment, the selection depends on the template costs like TIMD. That means each candidate in the list generates the prediction on the template to get the template prediction such as predicted template and the template cost for each candidate is measured according to the distortion between the predicted template and reconstructed template. The candidate list is reordered according to the costs and/or the promising candidates with smaller costs are recorded. In another embodiment, the selection uses the first K candidate in the candidate list. When K is 1, the only one selected candidate is used to generate the mode-type prediction for the current block. When K is larger than 1, multiple hypotheses of prediction with each hypothesis generated by one selected candidate are used to form the mode-type prediction by a pre-defined weighting. In one embodiment, the pre-defined weighting follows the costs. For the prediction generated by the candidate with a higher cost, the weight for this prediction gets smaller.

### Generation of Inter Prediction

The inter prediction of CIIP can be generated by using one or more inter motion candidates.

In one embodiment, the inter motion candidates can refer to subblock-based inter motion candidates and the inter prediction can refer to subblock-based prediction. In particular, one or more subblock-based merge candidates may be used to generate the inter part of CIIP. This case is called subblock-based CIIP. Explicit signalling (i.e. additional flag such as subblock-based CIIP flag) can be used to indicate whether to use subblock-based CIIP for the current block. In one sub-embodiment, the subblock-based motion candidates are from a subblock merge candidate list which is unified with original subblock merging candidates for affine and SbTMVP. An index (or more than one indices) indicating specific one or more candidates in the subblock-based merge list is (are) signalled and/or the first N (i.e. 1 or any pre-defined positive integer smaller than or equal to the size of the list) candidate(s) in the subblock-based merging candidate list with reordering is selected. In one sub-embodiment, subblock-based CIIP can be supported for CIIP-TM. That is, the subblock-based merge candidate(s) here is (are) refined by TM. In one sub-embodiment, subblock-based CIIP can be supported for CIIP-PDPC. In this case, when using subblock-based CIIP, the intra part can be CIIP-PDPC. In one sub-embodiment, a forbidden setting is pre-defined for subblock-based CIIP. The forbidden setting is that in the pre-defined cases, the inter part of CIIP cannot be generated using any subblock inter motion candidates and/or the signalling of subblock-based CIIP can be bypassed and inferred as disabled. In one case, CIIP-TM and subblock-based CIIP cannot be used at the same time. If CIIP-TM flag is true, subblock-based CIIP is forbidden. (i.e., when CIIP flag is true and CIIP-TM flag is false, a subblock-based CIIP can be allowed.) In another case, subblock-based CIIP and CIIP-PDPC cannot be used at the same time. If subblock-based CIIP flag is true, TIMD is used to generate intra signal by default without CIIP-PDPC flag signalled.

In another embodiment, the inter prediction can refer to GPM prediction which is generated as GPM or any GPM variations such as GPM-TM, GPM-MMVD, GPM-intra, and/or any combination or extension from the above-mentioned variations. In particular, a GPM merge candidate pair may be used to generate the inter part of CIIP. This case is called GPM-based CIIP. Explicit signalling (i.e. additional flag such as GPM-based CIIP flag) can be used to indicate whether to use GPM-based CIIP for the current block. In one sub-embodiment, the GPM-based motion candidate pair are from a GPM merge candidate list which is unified with original GPM merging candidates for GPM. Two indices indicating two specific candidates from the GPM merge list, respectively, are signalled and/or the first candidate pair in the GPM merging candidate list with reordering is selected. In one sub-embodiment, GPM-based CIIP can be supported for CIIP-TM. In this case, at least one or both GPM-based merge candidates are refined by TM. In one sub-embodiment, GPM-based CIIP can be supported for CIIP-PDPC. In this case, when using GPM-based CIIP, the intra part can be CIIP-PDPC. In one sub-embodiment, a forbidden setting is pre-defined for GPM-based CIIP. The forbidden setting is that in the pre-defined cases, the inter part of CIIP cannot be generated using GPM and/or the signalling of GPM-based CIIP can be bypassed and inferred as disabled. In one case, CIIP-TM and GPM-based CIIP cannot be used at the same time. If CIIP-TM flag is true, GPM-based CIIP is forbidden. (That is, when CIIP flag is true and CIIP-TM flag is false, a GPM-based CIIP can be allowed.) In another case, GPM-based CIIP and CIIP-PDPC cannot be used at the same time. If GPM-based CIIP flag is true, TIMD is used to generate the intra signal by default without CIIP-PDPC flag signalled.

In another embodiment, the inter prediction here can be replaced with any pre-defined block-vector prediction if the proposed methods are applied to the target mode referring to IBC or intraTMP and/or the inter prediction here can be the combination of more than one hypothesis of inter prediction and/or block-vector prediction. Also, the inter motion candidate here can refer to {motion vectors, reference indices} and/or {block vectors}.

### IV. Combined Prediction and Signalling

After determining the mode-type prediction in Section II and the inter prediction in Section III, the combined prediction is formed by using weighted averaging.

In one embodiment, if the mode using the combined prediction is CIIP, the weighted averaging follows the weighting used to combine with inter prediction in CIIP. For example, the weights (wIntra, wInter) are derived as shown in Table 4 if the intra prediction mode is an angular mode. For near-horizontal modes (for example, 2<=angular mode index<34), the current block is vertically divided into subblocks; for near-vertical modes (for example, 34<=angular mode index<=66), the current block is horizontally divided into subblocks.

TABLE 4
Weights for combined prediction

| Sub-block index | (wIntra, wInter) |
|---|---|
| 0 (near neighboring reference samples for intra) | (6, 2) |
| 1 | (5, 3) |
| 2 | (3, 5) |
| 3 (far away from neighboring reference samples for | (2, 6) |
| intra) | |

In another embodiment, the weighted average follows template costs such as TIMD. The weight for the hypothesis of prediction (either mode-type prediction or inter prediction) with a smaller template cost has a larger value.

In another embodiment, weights in the weighted average are derived using a regression-based derivation. The proposed weight setting to decide the weights is to estimate the relationship (e.g. minimizing the distortion) between the combining results (e.g. combined prediction) and the reconstructed samples on the reference region of the current block by a pre-defined regression method. A weighting (which may refer to model parameters) is then generated according to the regression method, and then to apply the weighting to derive the target (predicted) samples in the current block. In one embodiment, the pre-defined regression method can be linear minimum mean square error (LMMSE) method as for cross-component linear model (CCLM) or can be any unified method with the regression method used for CCLM. In another embodiment, the pre-defined regression method can be the LDL decomposition method as for CCCM or can be any unified method with the regression method used for CCCM. In another embodiment, the pre-defined regression method can be Gaussian elimination.

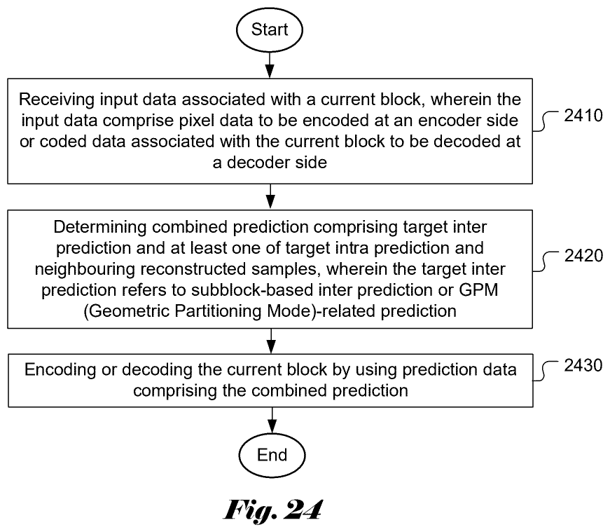

In one sub-embodiment, the reference region of the current block is the spatial neighbouring region of the current block, which may include only the spatial adjacent neighbouring region of the current block, only the spatial non-adjacent neighbouring region of the current block, both the spatial adjacent and non-adjacent neighbouring regions of the current block, and/or any pre-defined coded region. The reference region of the current block can vary with the block width, block height, block area, the signalling mode information of the current block, the signalling mode information of any neighbouring blocks and/or any coded blocks, and/or syntax elements on block, CTU, SPS, PPS, picture, slice, tile, and/or sequence level. The spatial neighbouring region of the current block 2310 includes above reference region 2320, left reference region 2330, above-left reference region 2340, and/or any subset of the above as shown in FIG. 23. The size of the above reference region is A_{W}×A_{H}, the size of the left reference region is L_{W}×L_{H}, and the size of the above-left reference region is AL_{W}×AL_{H}, where
A_{W}=block width of the current block (W), k*W, W+block height of the current block (H), any pre-defined value, or any adaptive value depending on the block position, block width, block height, and/or block area of the current block.
A_{H} or AL_{H}=H, any pre-defined value (e.g. 1, 2, 4, . . . ), or any adaptive value depending on the block position, block width, block height, and/or block area of the current block.
L_{W} or AL_{W}=W, any pre-defined value (e.g. 1, 2, 4, . . . ), or any adaptive value depending on the block position, block width, block height, and/or block area of the current block.
L_{H}=H, k*H, H+W, any pre-defined value, or any adaptive value depending on the block position, block width, block height, and/or block area of the current block.

In this example, the reference region is spatially adjacent to the current block. In other cases, the reference region may be spatially adjacent to the collocated block of the current block.

In one embodiment, the proposed combined prediction is used to replace the combined prediction in current CIIP design. That means when the enabling flag for CIIP indicates to apply CIIP to the current block, the proposed method is inferred to generate the final prediction of CIIP. In another embodiment, one additional flag is signalled to indicate whether the proposed combined prediction is used after the current block is already determined to code by a target mode. For example, the target mode is CIIP and/or the existing enabling flag of CIIP indicates that CIIP is applied to the current block. In another embodiment, the inter prediction used in the proposed combined prediction should be merge prediction, AMVP (advanced MVP) prediction, or merge prediction added with AMVP prediction. For another example, the target mode can be any mode mentioned in the related art such as CIIP, GPM, any GPM variations, IBC, and/or intraTMP. In another embodiment, after determining to use the proposed combined prediction for the current block, different weighting methods can be treated as different optional modes of the combined prediction mode. An implicit rule and/or an explicit mode index indication is used to select the optional mode of the combined prediction for the current block. For example, Option 1 uses fixed weighting to combine and/or Option 2 uses regression weighting to combine.

In one embodiment, the proposed methods in this invention can be enabled and/or disabled according to implicit rules (e.g. block width, height, or area) or according to explicit rules (e.g. syntax on block, tile, slice, picture, SPS, or PPS level). For example, the proposed method is applied when the block area is smaller/larger than a threshold. In another embodiment, the proposed method uses the DIMD process to derive an intra prediction mode of the current block based on the used predicted samples, such as all or any subset of the combined predicted samples and/or intermediate predicted samples (i.e. any hypothesis of prediction, which will be used to form the combined prediction) before combining predicted samples. In this case, a horizontal gradient and a vertical gradient are calculated for each used predicted sample to build a histogram of gradient (HoG). Then, the intra prediction mode corresponding to the largest histogram count is used to determine the transform set in the transform process of the current block and/or the coding process of the following coding blocks.

In one example, the transform process of the current block can be LFNST, NSPT, and/or MTS. Note that in this invention, LFNST/NSPT/MTS can be used in the transform process for only intra blocks, for only inter blocks, or only for a third type (not intra and not inter) blocks, and/or for any subset or combination of the above. For another example, the coding process of the following coding blocks can refer to the MPM (or merge list) construction and/or any inheritance scheme of the following coding block. When the following coding blocks reference (or inherit) the intra prediction mode of the current block, the derived intra prediction mode of the current block can be referenced. For another example, in the case of the current block being luma and the following coding block being chroma, the chroma DM of the following coding block can use the derived intra prediction mode of the current block if the current block is the collocated luma block of the following coding chroma block.

The term “block” in this invention can refer to TU/TB, CU/CB, PU/PB, pre-defined region, or CTU/CTB.

Any combination of the proposed methods in this invention can be applied.

Any of the foregoing proposed methods of extending the inter prediction part of combined prediction to refer to subblock-based inter prediction or GPM (Geometric Partitioning Mode)-related prediction can be implemented in encoders and/or decoders. For example, any of the proposed methods can be implemented in an inter/intra/IBC/prediction/transform module of an encoder, and/or an inter/intra/IBC/prediction/transform module of a decoder. Alternatively, any of the proposed methods can be implemented as a circuit coupled to the inter/intra/IBC/prediction/transform module of the encoder and/or the inter/intra/IBC/prediction/transform module of the decoder, so as to provide the information needed by the inter/intra/IBC/prediction/transform module.

FIG. 24 illustrates a flowchart of an exemplary video coding system that derives combined prediction by using target inter prediction referring to subblock-based inter prediction or GPM (Geometric Partitioning Mode)-related prediction according to an embodiment of the present invention. The steps shown in the flowchart may also be implemented based on hardware such as one or more electronic devices or processors arranged to perform the steps in the flowchart. According to the method, input data associated with a current block is received in step 2410, wherein the input data comprise pixel data to be encoded at an encoder side or coded data associated with the current block to be decoded at a decoder side. Combined prediction comprising target inter prediction and at least one of target intra prediction and neighbouring reconstructed samples is determined in step 2420, wherein the target inter prediction refers to subblock-based inter prediction or GPM (Geometric Partitioning Mode)-related prediction. The current block is encoded or decoded by using prediction data comprising the combined prediction in step 2430.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of prediction for colour pictures, the method comprising:
receiving input data associated with a current block, wherein the input data comprise pixel data to be encoded at an encoder side or coded data associated with the current block to be decoded at a decoder side;
determining combined prediction comprising target inter prediction and at least one of target intra prediction and neighbouring reconstructed samples, wherein the target inter prediction refers to subblock-based inter prediction or GPM (Geometric Partitioning Mode)-related prediction; and
encoding or decoding the current block by using prediction data comprising the combined prediction.

2. The method of claim 1, wherein explicit signalling is used to indicate whether to use subblock-based CIIP (Combined inter and intra prediction) for the current block or to indicate whether to use GPM-based CIIP for the current block.

3. The method of claim 1, wherein the subblock-based inter prediction is generated using one or more subblock-based motion candidates from a subblock merge candidate list.

4. The method of claim 3, wherein the subblock merge candidate list is unified with subblock merge candidates for affine and SbTMVP (Subblock-based Temporal Motion Vector Prediction) modes.

5. The method of claim 1, wherein subblock-based CIIP is supported for CIIP-TM (Template Matching), CIIP-PDPC (Position Dependent intra Prediction Combination), or both.

6. The method of claim 1, wherein the GPM-related prediction is generated using GPM-TM, GPM-MMVD (Merge mode with Motion Vector Differences), GPM-intra, or any combination or extension thereof.

7. The method of claim 1, wherein GPM-based CIIP is supported for CIIP-TM, CIIP-PDPC, or both.

8. The method of claim 1, wherein the combined prediction is formed by using said neighbouring reconstructed samples to blend with the target inter prediction.

9. The method of claim 1, wherein the target inter prediction is generated using one or more inter motion candidates being refined by template matching.

10. The method of claim 9, wherein said one or more inter motion candidates correspond to one or more merge candidates after said template matching.

11. The method of claim 1, wherein the target intra prediction and the target inter prediction are blended using blending weights and multiple blending methods with different weights are treated as multiple optional modes of combined prediction mode.

12. The method of claim 1, wherein one or more intra modes are determined using histogram analysis process.

13. The method of claim 12, wherein said one or more intra modes corresponding to a largest histogram count is used to determine a transform set in transform process of the current block and/or a coding process of following coding blocks.

14. The method of claim 13, wherein the transform process of the current block corresponds to LFNST (Low Frequency Non-Separable Transform), NSPT (Non-Separable Primary Transform), MTS (Multiple Transform Selection), or a combination thereof.

15. An apparatus for video coding, the apparatus comprising one or more electronics or processors arranged to:
receive input data associated with a current block, wherein the input data comprise pixel data to be encoded at an encoder side or coded data associated with the current block to be decoded at a decoder side;
determine combined prediction comprising target inter prediction and at least one of target intra prediction and neighbouring reconstructed samples, wherein the target inter prediction refers to subblock-based inter prediction or GPM (Geometric Partitioning Mode)-related prediction; and
encode or decode the current block by using prediction data comprising the combined prediction.
